(19) United States
(12) Patent Application Publication
(10) Pub. No.: US 2015/0225990 A1
(43) Pub. Date: Aug. 13, 2015

(54) VIBRATION TOLERANT DAMPER

(71) Applicant: AVM INDUSTRIES, Marion, SC (US)

(72) Inventor: Mark Manuel, Conway, SC (US)

(73) Assignee: AVM INDUSTRIES, Marion, SC (US)

(21) Appl. No.: 14/179,720

(22) Filed: Feb. 13, 2014

(51) Int. Cl. E05F 1/10; F16F 13/00

(52) U.S. Cl. CPC E05F 1/1091; F16F 13/002

(57) ABSTRACT

An example vibration tolerant damper includes an outer tube, a shaft received within the outer tube, and a piston valve received within the outer tube. The shaft moves together with the piston valve as the shaft extends and retracts through a first range relative to the outer tube. The shaft moves independently from piston valve as the shaft as the shaft extends and retracts through a second range relative to the outer tube.

### BACKGROUND

The disclosure relates generally to a damper that tolerates vibrations.

Dampers absorb energy. Dampers can absorb the energy of one component moving relative to another component. For example, dampers absorb energy of a vehicle hood closing relative to a chassis of a motor vehicle. The dampers control the rate at which the hood descends to a closed position.

Dampers may be exposed to vibrations. The vehicle hood can vibrate relative to the chassis when the motor vehicle is driven, for example. Vibrations can damage dampers. Dampers in large vehicles are especially prone to such damage due to the high vibratory amplitudes.

### SUMMARY

A vibration tolerant damper according to an exemplary aspect of the present disclosure includes, among other things, an outer tube, a shaft received within the outer tube, and a piston valve received within the outer tube. The shaft can move independently from piston valve as the shaft as the shaft extends and retracts relative to the outer tube.

In another example of the foregoing vibration tolerant damper, the shaft moves together with the piston valve as the shaft extends and retracts through a first range relative to the outer tube, and the shaft can move independently from piston valve as the shaft as the shaft extends and retracts relative to the outer tube through a second range.

In another example of the foregoing vibration tolerant damper, the first range is greater than the second range.

In another example of any of the foregoing vibration tolerant dampers, the movement of the shaft through the first range is damped by the piston valve, and movement of the shaft through the second range is undamped by the piston valve.

In another example of any of the foregoing vibration tolerant dampers, the movement of the shaft through the first range is damped, and movement of the shaft through the second range is undamped.

In another example of any of the foregoing vibration tolerant dampers, the dampers include a retainer that moves the piston valve with the shaft when the shaft extends relative to the outer tube within the first range, the retainer secured to the shaft.

In another example of any of the foregoing vibration tolerant dampers, the vibration dampers include an area of the shaft having a reduced diameter relative to a primary body of the shaft. The piston valve is received over the area and the primary body moves the piston valves with the shaft when the shaft retracts relative to the outer tube within the first range.

In another example of any of the foregoing vibration tolerant dampers, the dampers include an orifice plate that moves with the piston valve.

In another example of any of the foregoing vibration tolerant dampers, the dampers include damping fluid within the cylinder that moves through openings in the piston valve to damp movement of the shaft through the first range.

In another example of any of the foregoing vibration tolerant dampers, the first range is more than 12 times greater than the second range

In another example of any of the foregoing vibration tolerant dampers, the shaft extends and retracts through a second range relative to the outer tube in response to vibrations.

In another example of any of the foregoing vibration tolerant dampers, the shaft is securable to a first component, and the tube is securable to a second component. The vibration is vibration of the first and second component relative to each other.

In another example of any of the foregoing vibration tolerant dampers, the first component is a vehicle hood and the second component is a vehicle chassis.

A method of damping components according to an exemplary aspect of the present disclosure includes, among other things, moving a piston valve together with a shaft as the shaft extends and retracts through a first range relative to an outer tube. The movement of the piston valve damping movement of the shaft, and moving the shaft relative to the piston valve as the shaft extends and retracts through a second range relative to an outer tube.

In another example of the foregoing method, moving the piston valve together with the shaft moves the piston valve though a hydraulic damping fluid within the outer tube to damp movement of the shaft.

In another example of any of the foregoing methods, the piston valve receives an area of the shaft having a reduced diameter relative to a primary body of the shaft portion.

In another example of any of the foregoing methods, movement of the piston valve over the area is limited on a first axial side by a retainer that is fixed to the shaft, and on an opposing second axial side by a primary body of the shaft.

In another example of any of the foregoing methods, the method includes providing lift assist to the components using the shaft.

A method of damping movement of a component according to an exemplary aspect of the present disclosure includes, among other things, damping movement of a shaft relative to an outer tube to slow movement of component from an open position to a closed position, and permitting undamped movement of shaft relative to the outer tube when the component is in the closed position.

In another example of the foregoing method, the method includes moving a piston damper through a damping fluid during the damping and not moving the piston damper through the damping fluid during the undamped movement.

In another example of any of the foregoing methods, the component is a hood.

The various features and advantages of the disclosed examples will become apparent to those skilled in the art from the detailed description. The figures that accompany the detailed description can be briefly described as follows.

### DESCRIPTION OF THE FIGURES

FIG. 1 shows a perspective view of an example vibration tolerant damper.

FIG. 2 shows the vibration tolerant damper of FIG. 1 in a retracted and closed position within a damped vehicle assembly.

FIG. 3 shows the vibration tolerant damper of FIG. 1 within the damped vehicle assembly of FIG. 2 in a partially extended and partially open position.

FIG. 4 shows the vibration tolerant damper of FIG. 1 within the damped vehicle assembly of FIG. 2 in a fully extended and fully open position.

FIG. 5 shows a side view of the vibration tolerant damper of FIG. 1.

FIG. 6 shows a section view at line 6-6 in FIG. 5.

FIG. 7 shows a close-up view of an end of the FIG. 6 section view when the vibration tolerant damper is in a retracted and neutral position.

FIG. 8 shows a close-up view of the end of FIG. 7 when the vibration tolerant damper is in a retracted and vibrated position.

FIG. 9 shows the end of FIG. 7 when the vibration tolerant damper is in another retracted and vibrated position.

FIG. 10 shows a perspective view of selected portions of the end of FIG. 7.

FIG. 11 shows another perspective view of selected portions of the end of FIG. 7.

FIG. 12 shows a close-up view of an end of the vibration tolerant damper of FIG. 6 opposite the end shown in FIGS. 7-9.

FIG. 13 shows a perspective view of an orifice plate shown of FIGS. 5-12.

FIG. 14 shows a perspective view of a piston valve shown of FIGS. 5-12.

FIG. 15 shows a perspective view of a retainer shown of FIGS. 5-12.

FIG. 16 shows a highly schematic view of another example damper.

### DETAILED DESCRIPTION

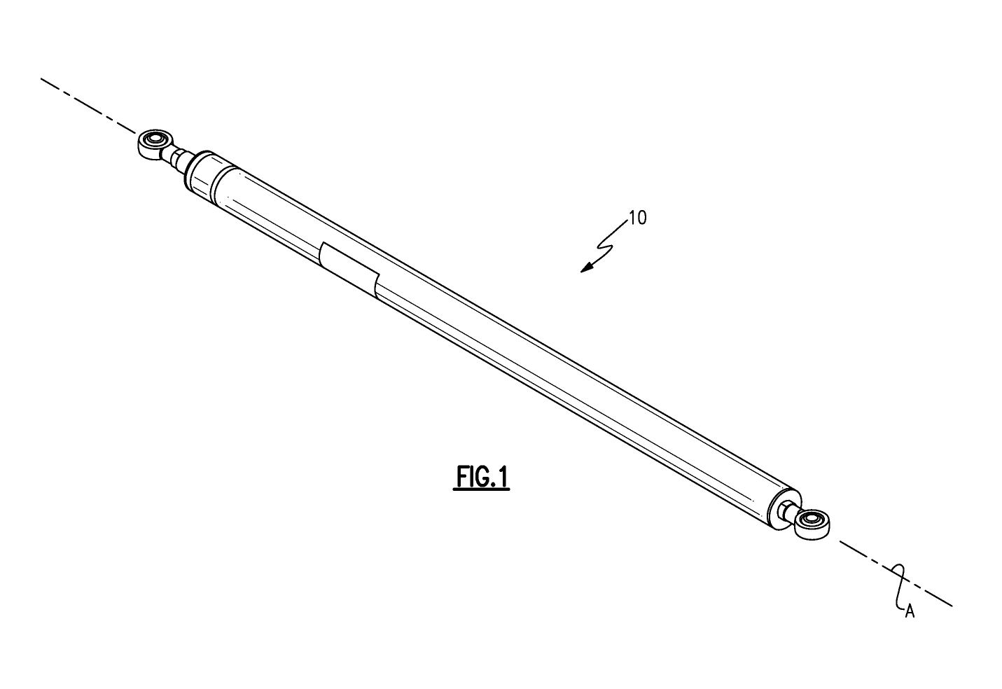

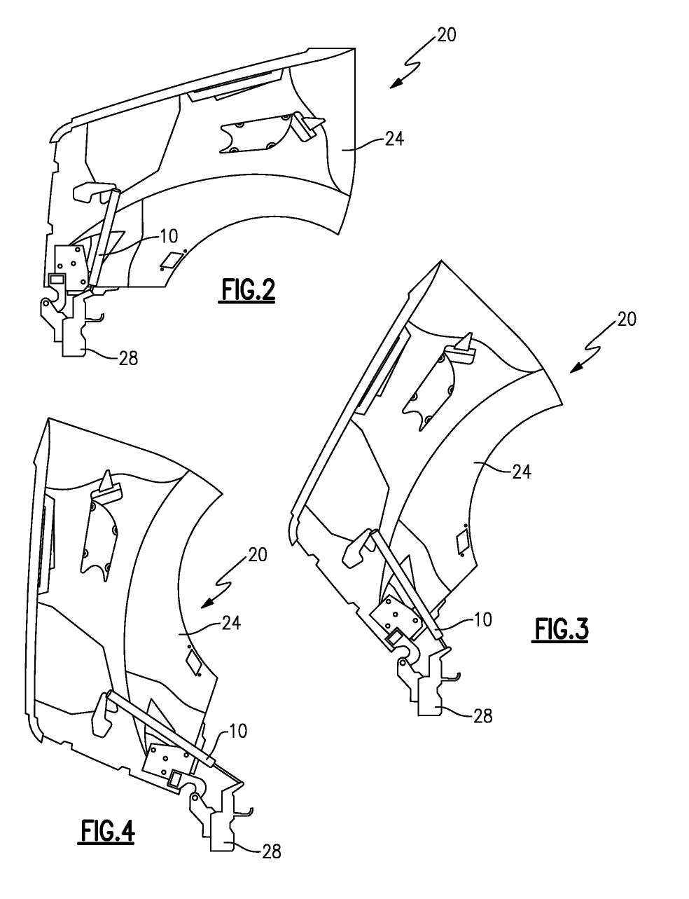

Referring to FIGS. 1-4, a vibration tolerant damper assembly 10 provides damping for a damped vehicle assembly 20. In this example, the damped vehicle assembly 20 includes a vehicle hood 24 and a vehicle chassis 28. The vehicle hood 24 moves between the closed position of FIG. 2 and the fully opened position of FIG. 2. The vibration tolerant damper 10 damps movement of the vehicle hood 24 relative to the vehicle chassis 28 when the vehicle hood 24 opens and when the vehicle hood 24 closes.

When the vehicle hood 24 is in the closed position of FIG. 2, the vehicle hood 24 may vibrate relative to the vehicle chassis 28. Vibration can damage dampers. This high force developed by the dampers can also damage the mounting hardware on the hood and chassis and even the hood itself.

In some examples, such as large trucks, relative movement between the vehicle hood 24 and the vehicle chassis 28 can be as high as +/−10 millimeters. This vibrational movement, if not accounted for, can exert high forces and significant heat on the dampers and cause very high mechanical forces that are transferred into the mounting hardware of the damper creating high stresses and mechanical failures

During damping, the vibration tolerant damper assembly 10 creates a resistive force that controls the speed of the vehicle hood 24 moving to the closed position of FIG. 2. During damping, the vibration tolerant damper 10 converts the energy of the vehicle hood 24 closing into heat by forcing hydraulic fluid to pass through relatively small openings. This creates a resistive force that can be matched to the forces exerted by the closure of the vehicle hood 24.

Although the example vibration tolerant damper 10 functions primarily to damp movement of the vehicle hood 24, a person having skill in this art and the benefit of this disclosure would understand that the vibration tolerant damper includes other types of dampers, such as those dampers that also provide a lift assistance. In such dampers, the movement of a single damper assembly would control the speed at which the vehicle hood 24 closes and also provide assistive force to facilitate moving the vehicle hood 24 to an open position.

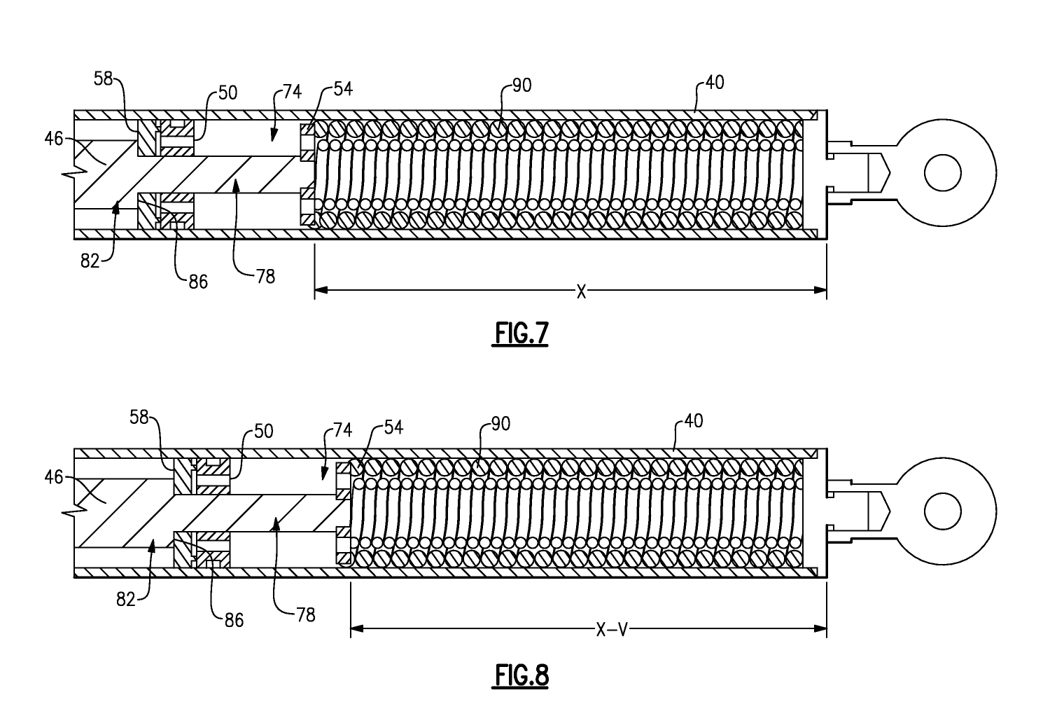

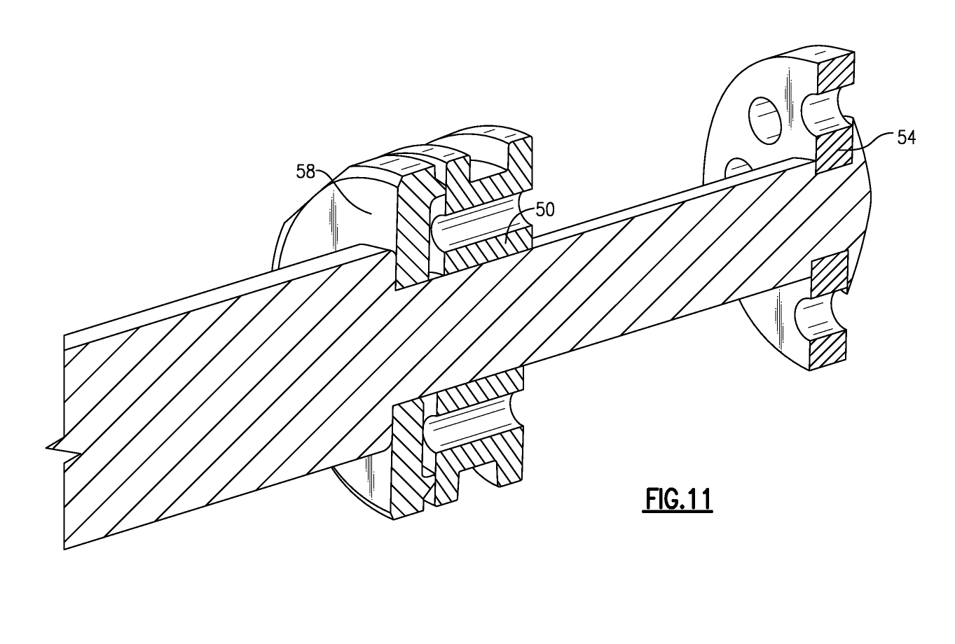

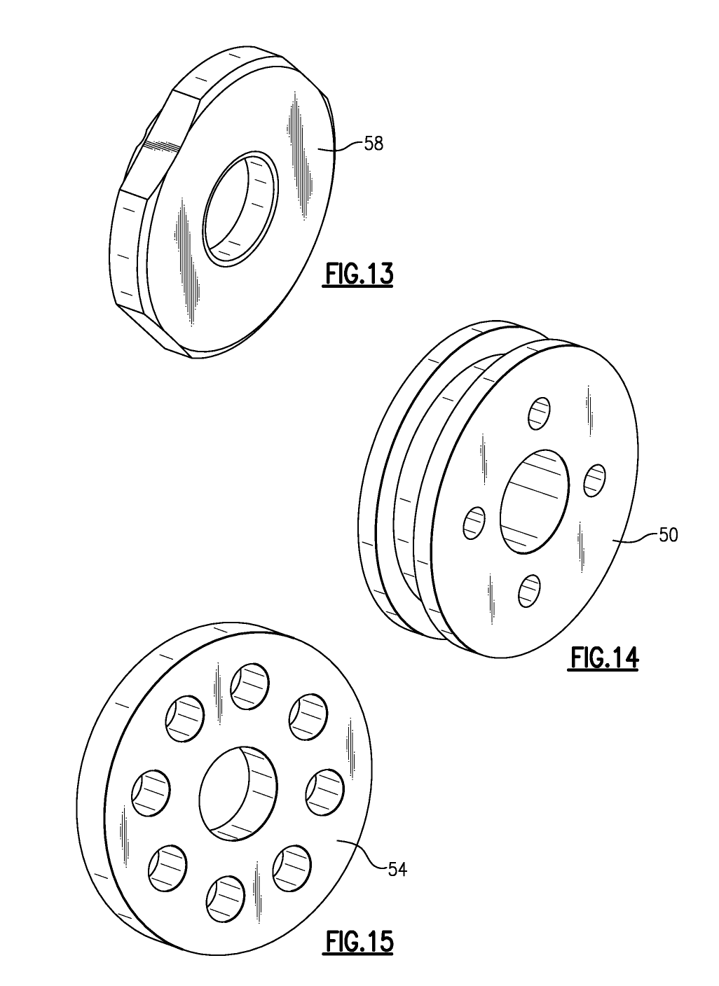

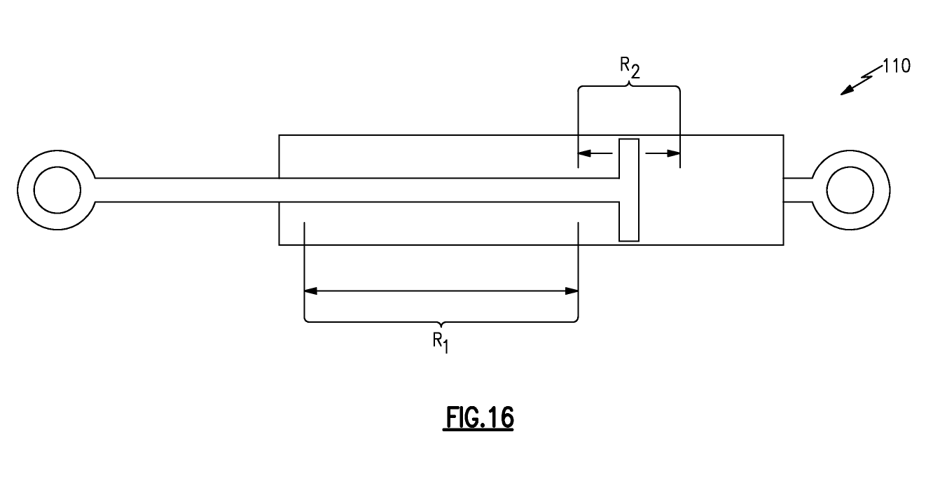

Referring now to FIGS. 5-15, the example vibration tolerant damper 10 includes an outer tube 40, a shaft 46, a piston valve 50, a retainer 54, and an orifice plate 58. The piston valve 50, the retainer 54, and the orifice plate 58 are received within the outer tube 40 along with an end 62 of the shaft 46. Another end 66 of the shaft 46 attaches to the vehicle chassis 28. An end 70 of the outer tube 40 attaches to the vehicle hood 24.

As the vehicle hood 24 moves between open and closed positions, the shaft 46 extends and retracts relative to the outer tube 40.

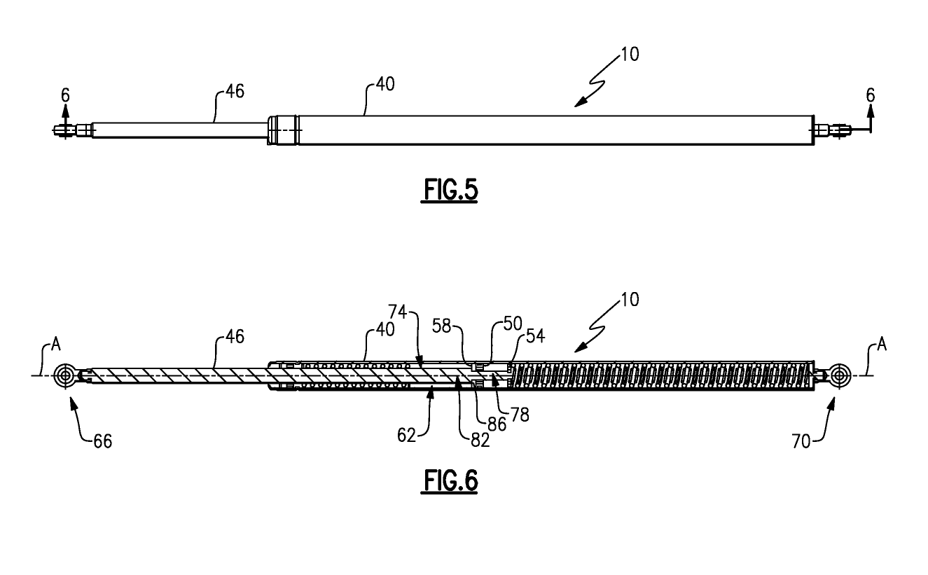

As the vehicle hood 24 moves from the fully open position of FIG. 4 to the fully closed position of FIG. 2, the shaft 46 moves through a first range of travel along an axis A relative to the outer tube. The shaft 46, when retracting, pushes the piston valve 50 through hydraulic damping fluid 74 contained within the outer tube 40 during movement from the position of FIG. 4 to the position of FIG. 2. Pushing the piston valve 50 forces the hydraulic fluid 74 through orifices within the piston valve 50, which slows movement of the piston valve 50 and thus movement of the shaft 46.

The piston valve 50 receives an area 78 of the shaft having a reduced diameter. The area 78 is reduced in diameter relative to the remaining primary portion 82 of the shaft 46. The transition or shoulder 86 between the area 78 and the primary portion 82 is what causes the piston valve 50 to move through the hydraulic fluid 74 as the shaft 46 retracts within the outer tube 40. Retraction of the shaft 46 as the vehicle hood 24 closes causes the shoulder 86 to push against the orifice plate 58, which then contacts the piston valve 50 to force the piston valve 50 through the hydraulic fluid 74.

Referring now to FIGS. 7-9 with continued reference to FIGS. 2-6, the positioning of the shaft 46 in the retracted position is represented in FIG. 7. Retracting the shaft, in addition to moving the piston valve 50 through the hydraulic fluid 74 urges the retainer 54 at least one compression spring 90 within the outer tube 40.

When the shaft 46 is in a neutral and closed position as shown in FIG. 7, the at least one spring 90 is compressed a distance X. The vehicle hood 24 and vehicle chassis 28 may then move, such as when the vehicle is driven. There are dampers that do not have springs

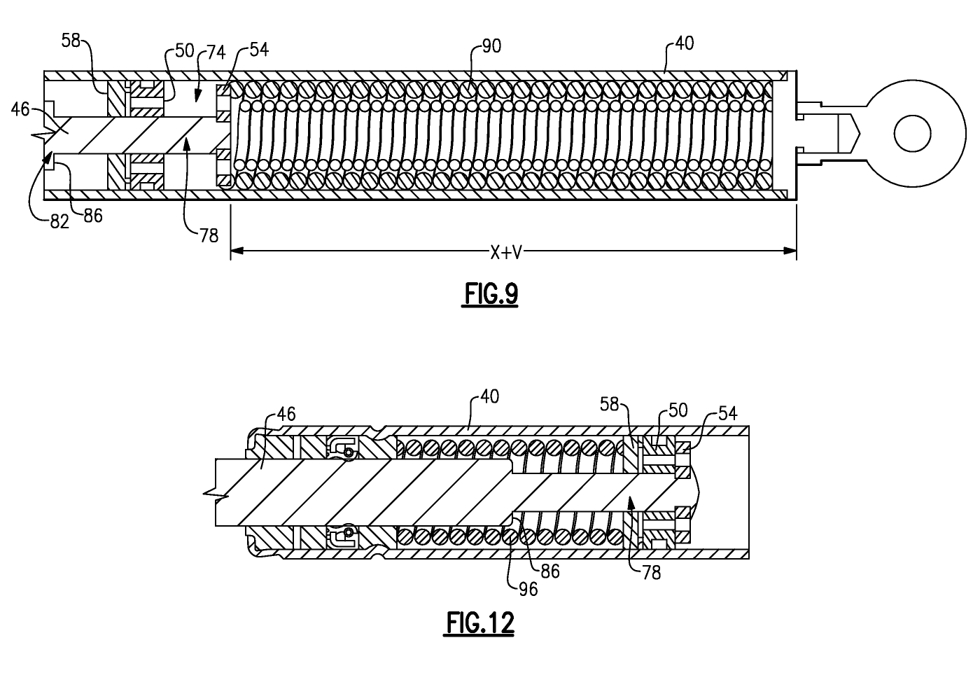

In this example, movement of the vehicle having the vehicle hood 24 may induce vibrations causing the vehicle hood 24 to move relative to the vehicle chassis 28 even though the vehicle hood 24 is closed and latched. Vibrations can move the vehicle hood 24 closer to the vehicle chassis 28 causing the shaft 46 to retract further into the outer tube 40 as shown in FIG. 8. This moves the retainer 54 against the at least one spring 90 compressing the at least one spring 90 further to about 10 millimeters, which, in this example, is represented by a distance of X−V.

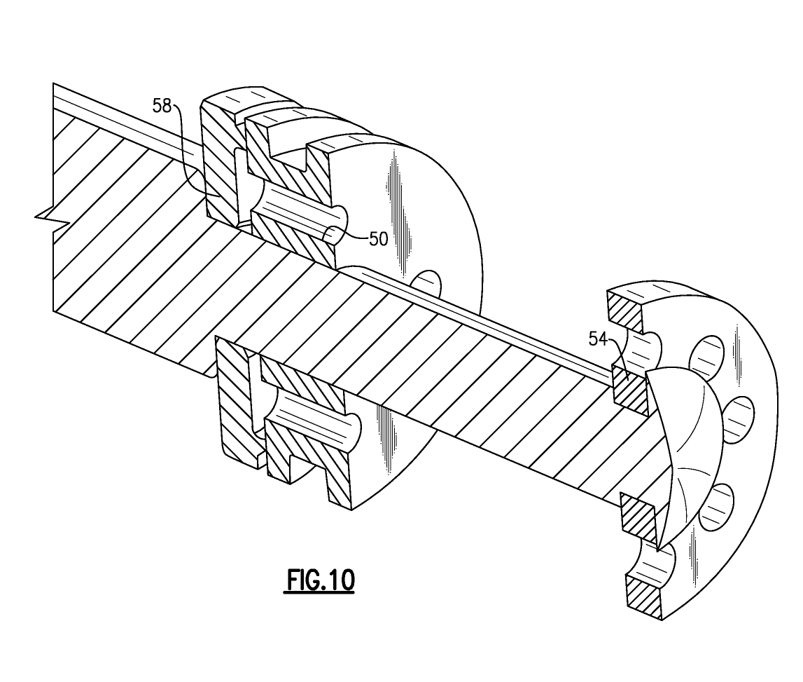

As the vibration oscillates in another direction, the shaft 46 extend from the outer tube 40 as shown in FIG. 9. This moves the retainer 54 permitting the at least one spring 90 to expand to a distance X+V as shown in FIG. 9.

Notably, the piston valve 50 and orifice plate 58 are not directly attached to the shaft 46. The orifice plate 58 and piston valve 50 are free to move along the area 78 of the shaft 46 relative to the shaft 46.

Because the piston valve 50 and orifice plate 58 are free to move relative to the shaft 46 when the vehicle hood 24 is closed, the piston valve 50 does not damp movement of the shaft 46 relative to the outer tube 40 when the vehicle hood 24 is closed.

Vibratory movement of the vehicle hood 24 relative to the vehicle chassis 28 is movement within a second range less than the first range of movement. The extent of the example second range are shown by FIGS. 8 and 9 respectively. The first range, by contrast, extends from the position of FIG. 2 to the position of FIG. 4. The first range is more than twelve times greater than the second range, in this example. The ratio can depend on a particular application and can be lower of higher than twelve. The amplitude of the vibration will determine the ratio in some examples.

When the vehicle hood 24 is moved by an operator, for example, from the closed position, the shaft 46 extends out from the outer tube. The extending movement of the shaft 46 exceeds the range of movement permitted within the second range.

The retainer 54 thus contacts the piston valve 50 and pulls the piston valve 50 through the hydraulic fluid 74 as the vehicle hood 24 moves to the fully opened position of FIG. 4. Movement to the fully opened position is damped by the hydraulic fluid 74 being forced through apertures in the piston valve 50 when the piston valve 50 is pulled through the hydraulic fluid 74.

Notably, because the initial movement of the vehicle hood 24 when opened is through the second range, this movement is not damped as. During the initial movement shaft has not extended far enough to pull the retainer 54 into contact with the piston valve 50. Thus, efforts to open the vehicle hood 24 are not supplemented by damping from the piston valve 50. The damping occurs once the shaft 46 has extended to a position where the retainer 54 contacts the piston valve 50.

Referring to FIG. 10, the shaft 46 is shown in a fully extended position relative to the outer tube 40, which corresponds to the fully opened position of the vehicle hood 24 shown in FIG. 4. In this position, the retainer 54 has pulled the piston valve 50 through the hydraulic fluid with the orifice plate 58.

The extending movement of the shaft 46 is damped due to the movement of the hydraulic fluid 74 through openings within the piston valve 50 and, in this example, the retainer 54. The fully extended shaft 46 compresses at least one spring 96 at an end of the outer tube 40 opposite the end having the at least one spring 90.

When moving from the fully opened position of FIG. 4 shown and the close-up shown in FIG. 10, the at least one spring 96 will keep the orifice plate 58 and piston valve 50 against the retainer 54. Eventually, the spring 96 is fully extended, at that point, the shaft 46 continues to retract within the outer tube until the shoulder 86 contacts the orifice plate to continue moving the orifice plate 58 and the piston valve 50. The orifice plate 58 and the piston valve 50 slide over the area 78 of the piston until the orifice plate 58 contacts the shoulder 86 as the vehicle hood 24 closes.

Referring to FIG. 16, an example damper 110 includes a piston that moves relative to an outer tube through a first range R1 and a second range R2. Movement through the second range R2 is damped. Movement through the first range is not

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. A vibration tolerant damper, comprising:
an outer tube;
a shaft received within the outer tube;
a piston valve received within the outer tube; and
an orifice plate received within the outer tube and moveable together with the piston valve, wherein the shaft can move independently from the piston valve as the shaft extends and retracts relative to the outer tube, wherein the orifice plate is rigid.

2. The vibration tolerant damper of claim 1, wherein the shaft moves together with the piston valve as the shaft extends and retracts through a first range of movement relative to the outer tube, and the shaft can move independently from piston valve as the shaft as the shaft extends and retracts relative to the outer tube through a second range of movement, wherein the first range of movement is greater than the second range of movement.

3. (canceled)

4. (canceled)

5. The vibration tolerant damper of claim 2, wherein the movement of the shaft through the first range is damped, and movement of the shaft through the second range is undamped.

6. The vibration tolerant damper of claim 2, further comprising a retainer and a coil spring, the retainer to move the piston valve with the shaft when the shaft extends relative to the outer tube within the first movement, the retainer secured to the shaft, the coil spring to spring bias the retainer when the retainer moves the piston valve with the shaft when the shaft reaches a predetermined position.

7. The vibration tolerant damper of claim 2, further comprising an area of the shaft having a reduced diameter relative to a primary body of the shaft, wherein the piston valve is received over the area and the primary body moves the piston valve with the shaft when the shaft retracts relative to the outer tube within the first range.

8.-9. (canceled)

10. The vibration tolerant damper of claim 2, wherein the first range is more than 12 times greater than the second range.

11. The vibration tolerant damper of claim 2, wherein the shaft extends and retracts through the second range relative to the outer tube in response to vibrations.

12. The vibration tolerant damper of claim 11, wherein the shaft is securable to a first component, and the tube is securable to a second component, wherein the vibration is vibration of the first and second component relative to each other.

13. The vibration tolerant damper of claim 12 within a damped vehicle assembly, wherein the first component is a vehicle hood and the second component is a vehicle chassis, the vibration tolerant damper including a coil spring to provide a lift assist of the vehicle hood relative to the vehicle chassis.

14. A method of damping components, comprising:
moving a piston valve together with a shaft as the shaft extends and retracts through a first range of movement relative to an outer tube, the movement of the piston valve and a rigid orifice plate damping movement of the shaft; and
moving the shaft relative to the piston valve as the shaft extends and retracts through a second range of movement relative to an outer tube, the second range of movement, wherein the first range of movement is greater than the second range of movement.

15. The method of claim 14, wherein moving the piston valve together with the shaft moves the piston valve though a hydraulic damping fluid within the outer tube to damp movement of the shaft.

16. The method of claim 14, wherein the piston valve receives an area of the shaft having a reduced diameter relative to a primary body of the shaft portion.

17. The method of claim 16, wherein movement of the piston valve over the area is limited on a first axial side by a retainer that is fixed to the shaft, and on an opposing second axial side by a primary body of the shaft.

18. The method of claim 16, further comprising using at least one coil spring to provide a lift assist to the components when the shaft extends.

19. A method of damping movement of a component, comprising:
damping movement of a shaft relative to an outer tube to slow movement of the component from an open position to a closed position;
permitting undamped movement of the shaft relative to the outer tube when the component is in the closed position; and
damping movement of the shaft relative to the outer tube to slow movement of the component from the closed position to an open position, wherein at least some of the movement of the component from the closed position to the open position is spring assisted movement.

20. (canceled)

21. The method of claim 19, wherein the component is a hood.

22. The vibration tolerant damper of claim 1, further comprising a first coil spring that spring biases the shaft toward an extended position.

23. The vibration tolerant damper of claim 22, further comprising a second coil spring that spring biases the orifice plate and the piston valve against a retainer when the shaft initially retracts from a fully extended position relative to the outer tube.

24. The vibration tolerant damper of claim 23, wherein the second coil spring is coiled circumferentially about at least a portion of the shaft.

25. The method of claim 14, wherein at least some of the movement through the first range of positions is spring assisted movement.

26. The method of claim 25, wherein the outer tube houses at least one coil spring that provides the spring assisted movement.

27. The method of claim 19, further comprising including moving a piston damper and a rigid orifice plate through a damping fluid during the damping and not moving the piston damper and a rigid orifice plate through the damping fluid during the undamped movement.

28. The method of claim 27, wherein the outer tube houses at least one coil spring that provides the spring assisted movement.
